(19) United States
(12) Patent Application Publication
(10) Pub. No.: US 2006/0123449 A1
(43) Pub. Date: Jun. 8, 2006

(54) Handheld device that integrates personal information management with audio/video control

(76) Inventors: Yue Ma, West Windsor, NJ (US); Chieh-Chung Chang, Monmouth Junction, NJ (US); Deanna Wilkes-Gibbs, Palo Alto, CA (US); Robert S. Fish, Gillette, NJ (US); David A. Braun, Denville, NJ (US)

Correspondence Address: HARNESS, DICKEY & PIERCE, P.L.C., P.O. BOX 828, BLOOMFIELD HILLS, MI, 48303, US

(21) Appl. No.: 10/509,827

(22) PCT Filed: Mar. 31, 2003
(86) PCT No.: PCT/US03/09880

§ 371 Date: Jun. 28, 2005

Related U.S. Application Data
(60) Provisional application No. 60/370,561, filed on Apr. 5, 2002.

(51) Int. Cl. H04N 5/445; G06F 13/00; G06F 3/00

(52) U.S. Cl. 725/58

(57) ABSTRACT

A handheld device (12) integrates personal information scheduler (252) with a program list view (250) selection and operation of a wide variety of media devices. Specifically, the handheld device (12) includes a database containing program content downloaded during the vertical blanking interval (VBI) or from the Internet (174). Viewing the EPG database and personal calendar simultaneously, the user incorporates program into his/her personal schedule for viewing or recording. Further, the device is capable of analyzing usage patterns to set defaults of the handheld device, and other devices under its control, according to user preferences.

### FIELD OF THE INVENTION

The present invention relates generally to the control of audio, video, and multimedia equipment. More specifically, the present invention relates to the use of a personal information management device to integrate personal calendared events with the operation of audio, video, and multimedia equipment.

### BACKGROUND OF THE INVENTION

Millions of consumers use some form of handheld device (such as a personal digital assistant (PDA) or cellular telephone) to perform personal information management (PIM) functions such as address book, phonebook and appointment calendar functions. These same consumers often plan their personal schedule around their favorite television programs or record (timeshift) their favorite television programs for viewing at a convenient time. While electronic program guide information is currently available from the Internet or from traditional analog broadcasts, there is currently no convenient and automated way to schedule television viewing and recording operations along with other PIM calendared events. Further, current handheld devices are difficult to use and are passive as they fail to provide the user with the capability of downloading and storing video clips for access at a later time.

Consequently, there is a need for a handheld device that is able to integrate electronic program guide (EPG) information, obtained from either a television broadcast signal or from the Internet, with PIM calendar data and audio/video device control functionality. The handheld device should allow the user to select programs from the EPG and easily modify his/her personal schedule stored within the handheld device to include appointments to watch the programs selected. The handheld device should provide the user with the option of automatically recording the selected program using a suitable recording device such as a VCR. Further, the device should be able to learn and analyze the usage patterns of the user so as to set the defaults of the handheld device, and other devices under its control, according to the user's preferences. Finally, the device should enhance the user's multimedia experience by allowing the user to store media clips for either off-line viewing or integration with other information.

### SUMMARY OF THE INVENTION

The present invention overcomes the deficiencies of the prior art by providing a system that is capable of integrating personal information management (PIM) calendar data with program guide selection and the operation of a wide variety of audio/video devices. Specifically, the system includes a handheld device (such as a personal digital assistant (PDA) or a cellular telephone) outfitted with a database containing program content downloaded from auxiliary broadcasting channels such as vertical blanking interval (VBI) for analog broadcasting, MPEG transport stream data packet for digital broadcasting, optical encoding taught by U.S. Pat. No. 4,807,031 to Broughton et al, the Internet, or from other external memory sources (e.g. SD card). Viewing the EPG database and personal calendar simultaneously, the user is able to incorporate select programs into his/her personal schedule for viewing or recording. If the user is unable to view the program at its scheduled time, the system provides the user with the option of automatically recording the program using a suitable recording device such as a VCR. Further, the system is capable of learning and analyzing user usage patterns so as to set the defaults of the handheld device, and other devices under its control, according to the user's preferences. Finally, the system is capable of enhancing the user's multimedia experience by allowing the user to store media clips for either off-line viewing or integration with other information.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a system block diagram showing the general components of the invention, the invention providing a handheld device that integrates personal information management with audio/video control;

FIG. 2 is graph illustrating the different components a NTSC broadcast signal;

FIG. 3 is a block diagram illustrating detailed operation of the handheld device and the set-top box of FIG. 1 according to a first embodiment of the current invention;

FIG. 4 is a block diagram illustrating the operation of a set-top box of the current invention with certain components of the set-top box secured to a pluggable module that may be inserted within the set-top box;

FIG. 5 is a block diagram illustrating a television incorporating certain components of the set-top box illustrated in FIG. 3, the television communicating with a set-top box through a general purpose data port;

FIG. 6 is a block diagram illustrating the television of FIG. 5 communicating with a media bridge;

FIG. 7 is a block diagram illustrating the operation of a progressive handwriting search by a handwriting interpreter;

FIG. 8 is a block diagram illustrating an example of a progressive handwriting search by the handwriting interpreter;

FIG. 9 is a block diagram illustrating the operation of a word-based search carried out by the handwriting interpreter;

FIG. 10 is a block diagram illustrating the training of the handwriting interpreter to recognize a particular handwritten input;

FIG. 11 is a block diagram illustrating the training of the handwriting interpreter to recognize a particular handwritten input according to a second embodiment;

FIG. 12 is a block diagram illustrating the detailed operation of the handheld device and the set-top box of FIG. 1 according to a second embodiment of the current invention;

FIG. 13 is a screen snapshot showing the television remote control operation of the handheld device;

FIG. 14 is a screen snapshot of the EPG program list view displayed by the handheld device;

FIG. 15 is a screen snapshot of the EPG program mini-review displayed by the handheld device;

FIG. 16 is a screen snapshot of the EPG full review displayed by the handheld device;

FIG. 17 is a diagram illustrating the use of a synchronization engine to synchronize three different levels of EPG data;

FIG. 18 is an illustration of an EPG source table and a EPG data table;

FIG. 19 is a block diagram illustrating the construction of the EPG table and the construction of hyperlinks from one level of EPG information to another;

FIG. 20 is a block diagram illustrating the construction of hyperlinks from level 2 EPG data to level 3 EPG data;

FIG. 21 is a screen snapshot of the clip inventory screen of the handheld device;

FIG. 22 is a screen snapshot of the handheld device displaying live digital data received from a broadcast source, the data providing additional information concerning a product offered for sale; and

FIG. 23 is a screen snapshot of the handheld device displaying live digital data received from a broadcast source, the data representing an electronic coupon.

### DETAILED DESCRIPTION OF THE PREFERRED EMBODIMENTS

The following description of the preferred embodiment(s) is merely exemplary in nature and is in no way intended to limit the invention, its application, or uses.

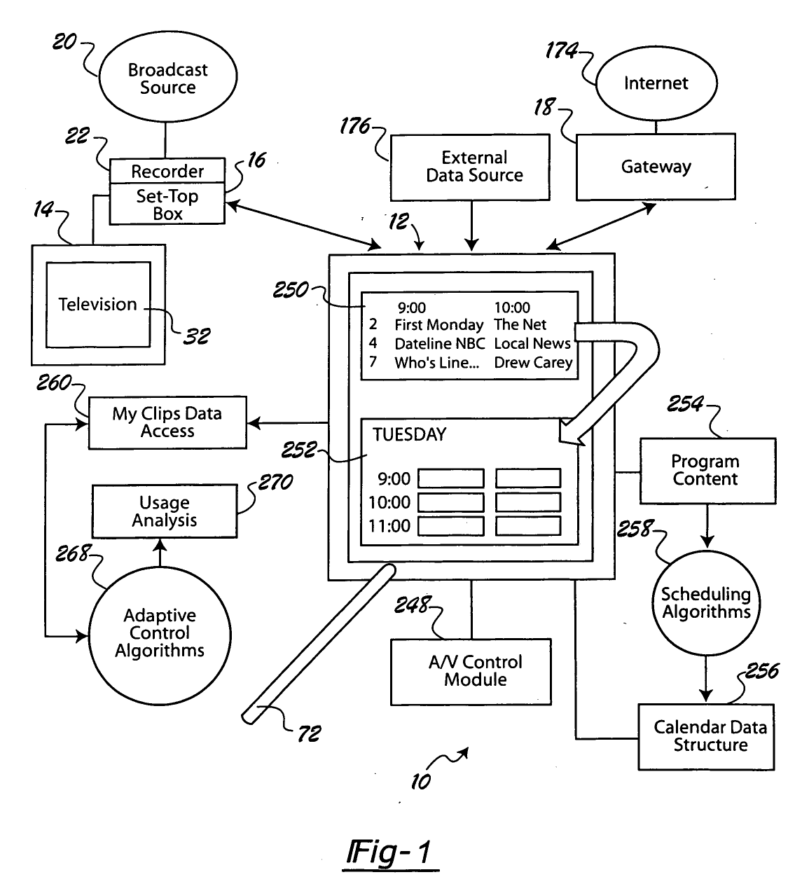

With reference to FIG. 1, a system 10 that integrates personal information management with audio/video control is shown. The system 10 is further capable of both storing multimedia data and manipulating its own control functions according to patterns of use. The system 10 generally comprises a handheld device 12, a television 14, a set-top box (STB) 16, an Internet gateway 18, and a broadcast source 20. It must be noted that while system 10 will generally be described in terms of television 14, any suitable electronic device such as a VCR 22 or DVD (NOT SHOWN) may be used in conjunction with television 14.

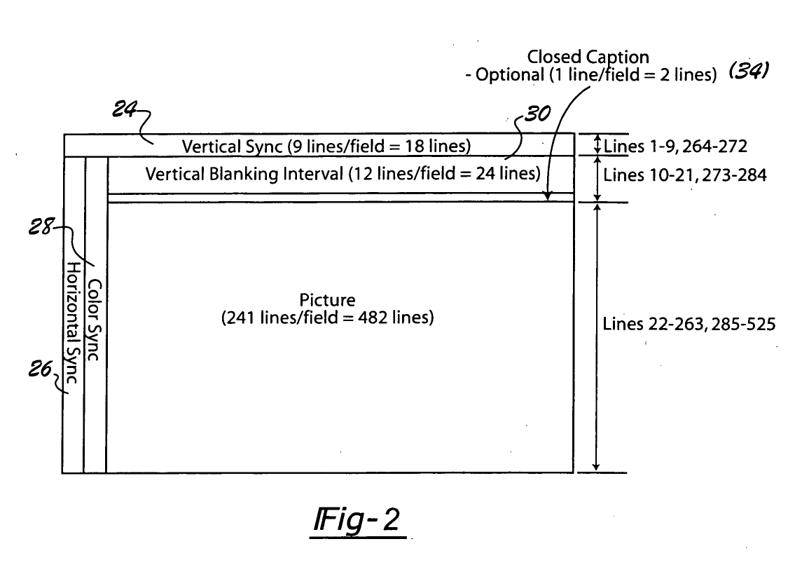

With continued reference to FIG. 1 and additional reference to FIGS. 2 through 23, the system 10 will now be described in further detail. Broadcast source 20 produces a signal that carries both audio/video signal and digital data. In analog broadcasting, digital data can be embedded within a vertical blanking interval (VBI) of the signal (described below). While the analog data encodes television audio and video, the digital data may be used to represent virtually any type of information including electronic program guide (EPG) data.

The video signal may be displayed in numerous formats. However, one of the most commonly used formats is NTSC, graphically illustrated in FIG. 2. As seen in FIG. 2, approximately the first 9 lines of the NTSC video signal are used for vertical synchronization 24 of the picture. Likewise, a portion of the signal is used for horizontal synchronization 26 and color synchronization 28. The first few lines of the picture information, approximately lines 10 through 21, are the vertical blanking interval (VBI) 30. Typically, this portion of the image is not displayed on screen 32 of television 14 and may be thought of as “appearing” just off the top of the screen 32. It is within the VBI 30 that the digital data sent by broadcast source 20 is embedded. A portion of the VBI 30 may also be devoted to closed captioning information 34. The remaining portion of the signal, approximately lines 22 through 263, represents the viewable portion of the signal.

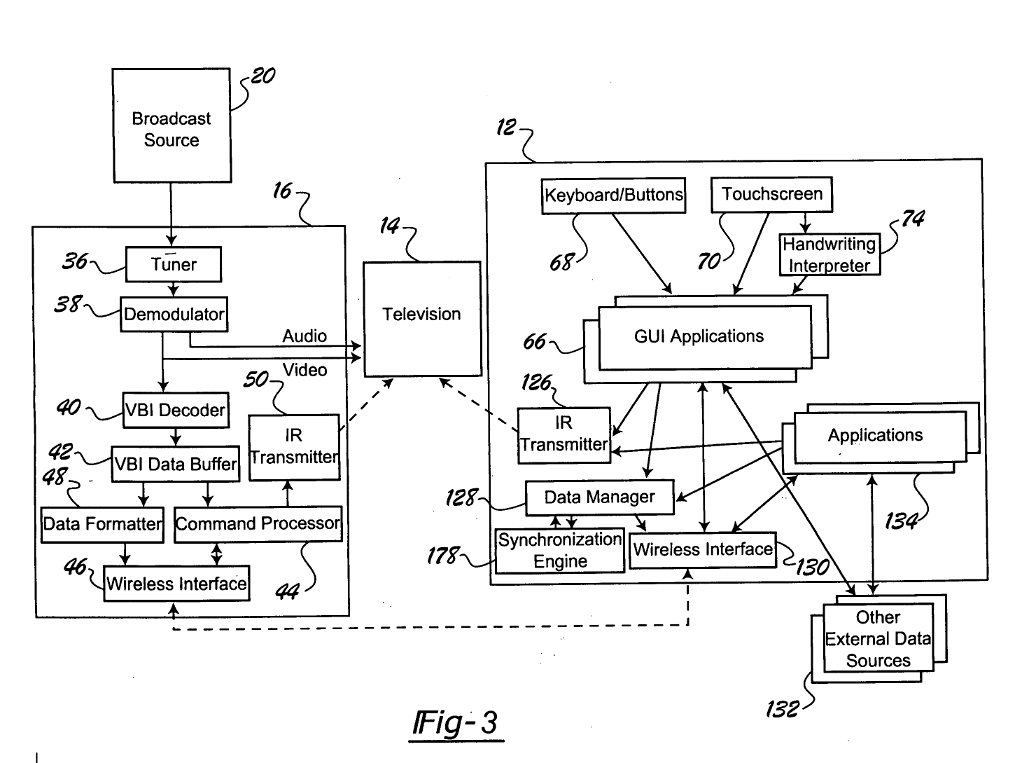

Operation of STB 16 and handheld device 12 is illustrated in FIG. 3 according to a first embodiment of the present invention. As seen in FIG. 3, the signal produced by broadcast source 20 is sent directly to tuner 36 of STB 16 where the desired channel is tuned. The audio and video components of the selected channel are then extracted from the signal using demodulator 38. The audio component is sent directly to television 14 and the video component is sent to a VBI decoder 40. The VBI decoder 40 is a hardware device that is capable of decoding the video data transmitted through the selected broadcast channel.

After the VBI data has been decoded by decoder 40 the data is stored in a VBI data buffer 42. The VBI data buffer 42 is necessary as VBI data is only sent at a certain time interval on each channel and thus can not be made instantaneously available when a user sends a request unless it has been previously saved. When VBI data is requested from a particular channel at a specific time, the data in the VBI data buffer 42 is looked for instead. This guarantees that VBI data will be available whenever it is requested. In order to insure that the correct data is provided to the user, all VBI data is channel and time stamped as will be more fully descried below.

The STB 16 further comprises a command processor 44. The command processor 44 processes commands received from the handheld device 12 through a wireless interface 46 such as IEEE 803.11b or Bluetooth. If a command requests VBI data from the broadcast source 20, the VBI data is retrieved from the VBI data buffer 42, formatted by data formatter 48 and sent back to the handheld device 12 using the same wireless interface 46.

If the handheld device 12 transmits a command to the STB 16 for controlling television 14, or any other audio/video device, the command is received by the command processor 44 and sent to an IR transmitter 50. The IR transmitter 50 allows the handheld device 12 to realize all of the control functions of the television 14, or any other audio/video device. Use of IR transmitter 50 allows the user to operate the television 14 without having to point the handheld device 12 at the television 14 and allows the distance for controlling the television 12 to be extended further than IR. The control capabilities are only limited by the capabilities of the wireless communication channel. It must be noted that the command signal may also be transmitted directly to the television 12 without being first sent to the STB 16.

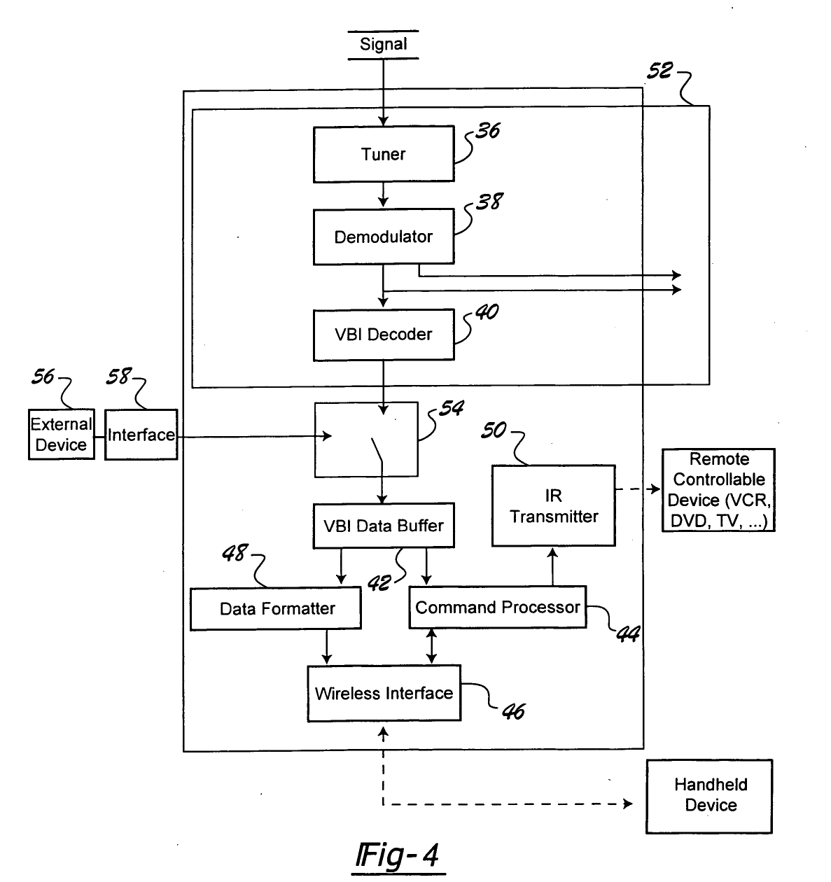

The tuner 36, demodulator 38, and VBI decoder 40 may either be permanently built into the STB or located upon an optional plug-in card/module 52 as seen in FIG. 4. The module 52 may include tuner 36, demodulator 38, and VBI decoder 40. The module 42 may also include a general purpose port interface (not shown). In conjunction with card/module 52, a switch 54 may be used for selection between VBI data received by tuner 36 or VBI data received from another external device 56. Before the VBI data from external device 56 is received by STB 16, the data is subject to conditioning circuitry such as line receivers at interface 58. The VBI data that exits switch 54 is raw VBI data stream data.

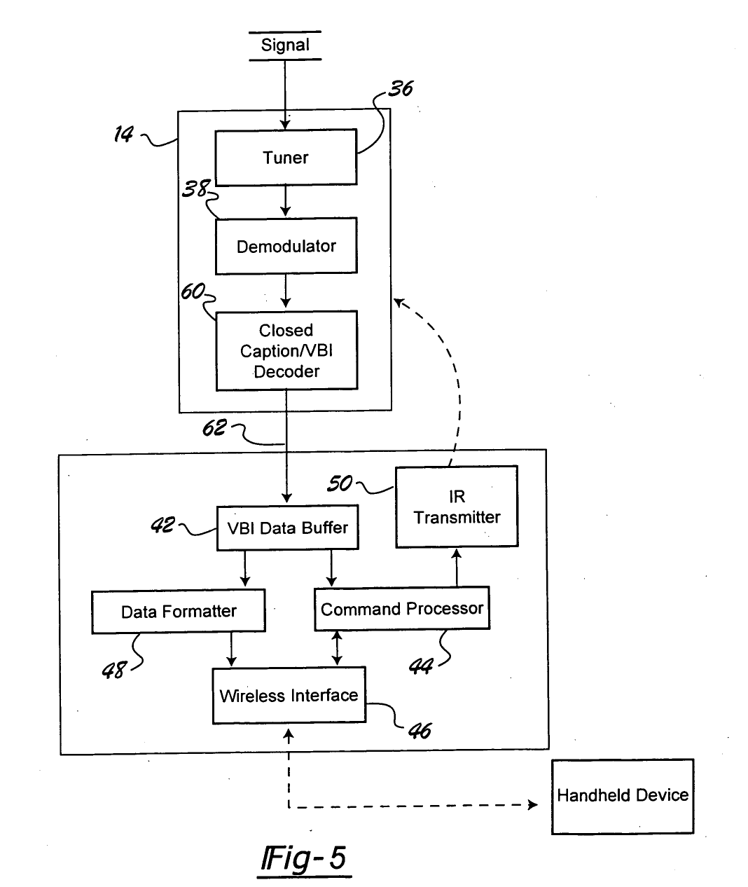

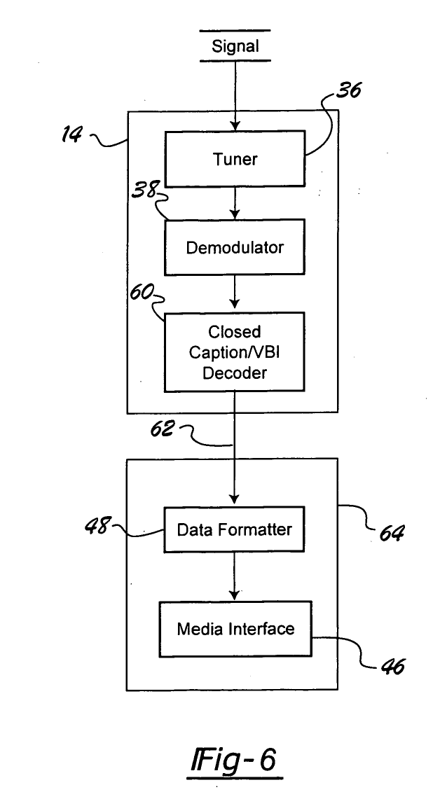

In addition to being located in the STB 16 as described above, tuner 36, demodulator 38, and VBI decoder 40 may be located within television 14 as shown in FIGS. 5 and 6. Further, television 14 may also be equipped with a closed caption decoder, the closed caption decoder capable of being combined with the VBI decoder 40 as shown in FIGS. 5 and 6 at 60. The VBI and CC data decoded at 60 may then be transmitted from television 14 via general purpose data port 62 to any external device such as STB 16 (FIG. 5) or any type of “media bridge,” such as bridge 64. Bridge 64 is comprised of data formatter 48 that is capable of reformatting the VBI data stream to be compatible with a particular media and then transmits the reformatted data using media interface 46. As described above, the media interface 46 may be any type of interface such as IEEE 802.11b, USB, IR, Bluetooth, etc.

The handheld device 12 of the first embodiment will now be described in detail. As illustrated in FIG. 3, the handheld device 12 is operated by the user through the use of a graphical user interface (GUI) application 66. The GUI application 66 can be written using numerous programming languages such as JAVA. Using the GUI 66, the user is able to operate most of the functions of the handheld device 12, the functions including but not limited to personal information management, remote operation of television 14, and remote operation of other types of audio/video equipment.

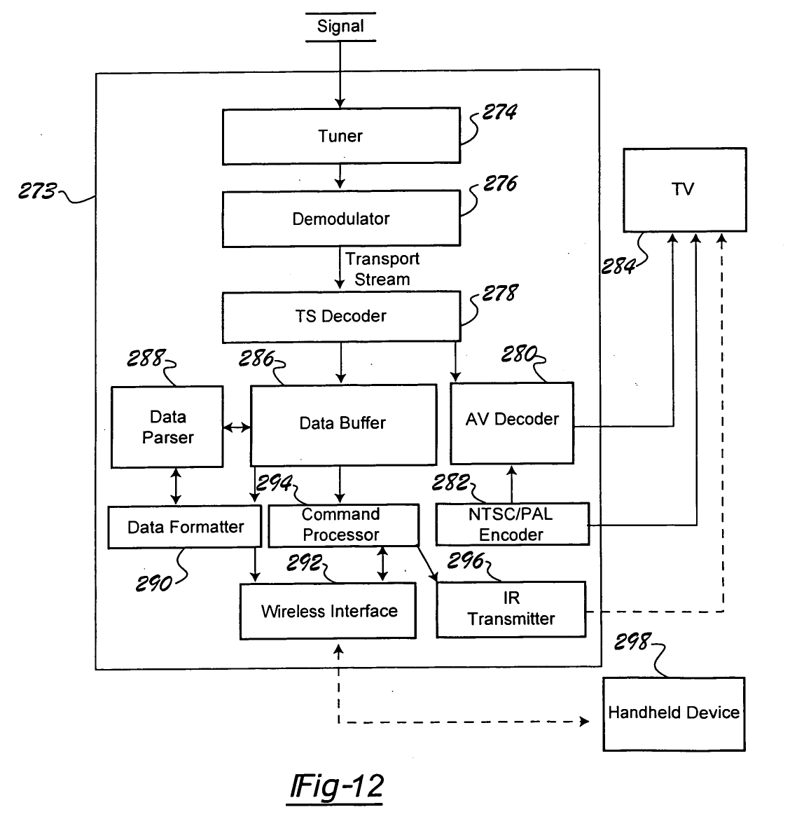

The preferred GUI 66 is illustrated in FIGS. 13 through 16, however, it must be noted that numerous different GUI's may be used. The user may interact with the GUI 66 in various different ways. The user may use buttons of a keyboard at 68, simply touch the screen of device 12 at 70, or use stylus 72 to input handwritten commands at 74. While all methods are suitable, the use of stylus 72 for inputting handwritten commands at 74 via a handwriting interpreter is preferred.

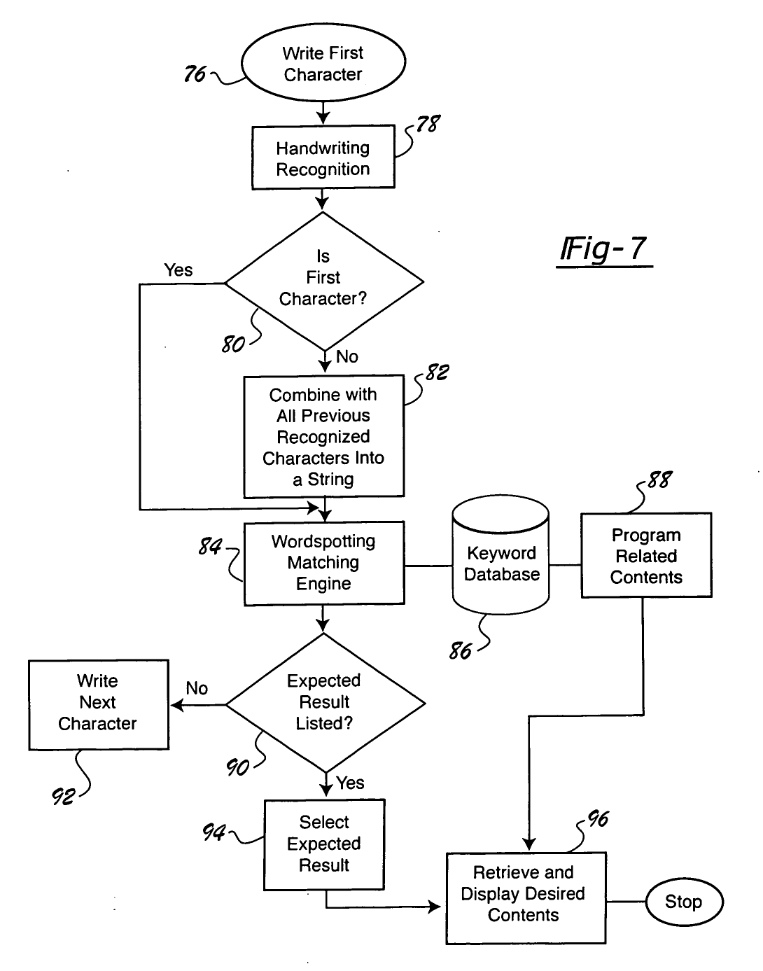

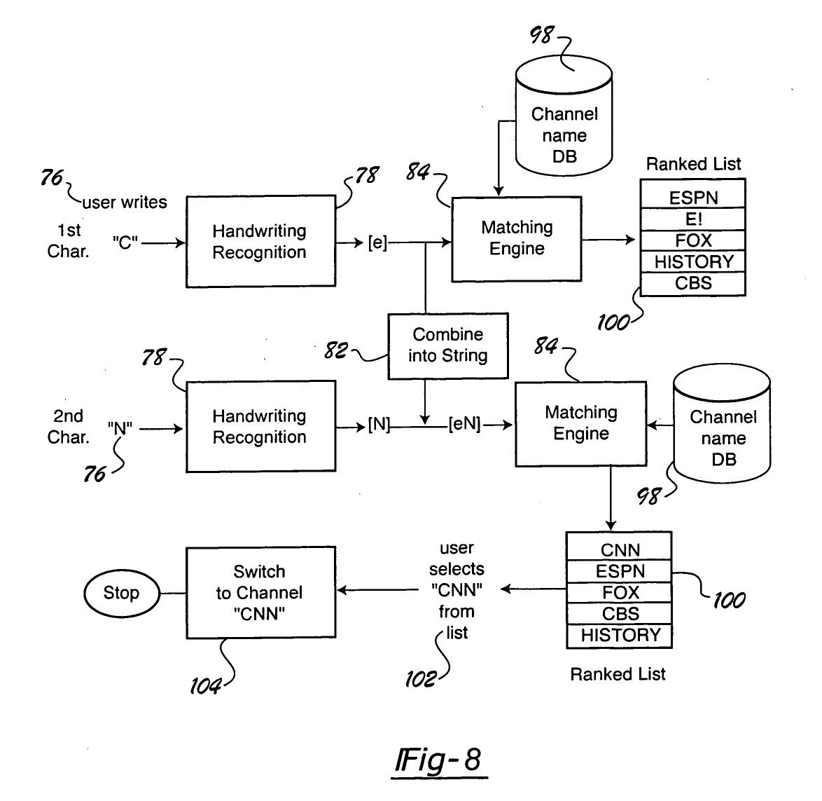

Operation of the handwriting interpreter 74 is described in detail in FIGS. 7 through 11. As seen in FIG. 7 and 8, handwriting may be analyzed character by character using a progressive search. After first character 76 is written it is analyzed by a handwriting recognition device 78. Then the process proceeds directly to the word spotting matching engine 84 with one-character string. When the second character or subsequent characters are entered, previously analyzed characters are combined into a multi-character string 82. Once a group of characters have been assembled, the process proceeds to the word spotting and matching engine 84.

The word spotting and matching engine 84 compares the query string to keywords found in keyword database 86 formed from program related contents 88 to return a list of keywords approximating that entered by the user. The user must then determine if the expected keyword or result is listed at step 90. If the expected keyword is not listed, the process proceeds to block 92 where the user is prompted to enter an additional character. The above process then repeats from step 78. If the expected result is listed, it is selected by the user at 94. The desired content associated with the handwritten entry is then obtained from the program related contents 88 at 96 and the character by character analysis of the handwriting input is complete.

An example of a progressive search is illustrated in FIG. 8. As seen in FIG. 8, if a user desires to locate a particular channel and inputs the letter “C” at 76 and the character is mis-recognized as “e” at 78, the methodology proceeds to word spotting matching engine 84. At word spotting matching engine 84 the recognized input is compared to the channel names within channel name database 98 to return ranked list 100. The user may then select the appropriate channel from the list 100 and the channel selected will be displayed. If the user input is not recognized, the input is combined into a string at 82 with an input 76 that is recognized at 78. The letters of the string are then associated with a channel name within channel database 98 by matching engine 84 to return ranked list 100. The user may then select the desired channel from the ranked list 100 at 102 and the selected channel will then be displayed at 104.

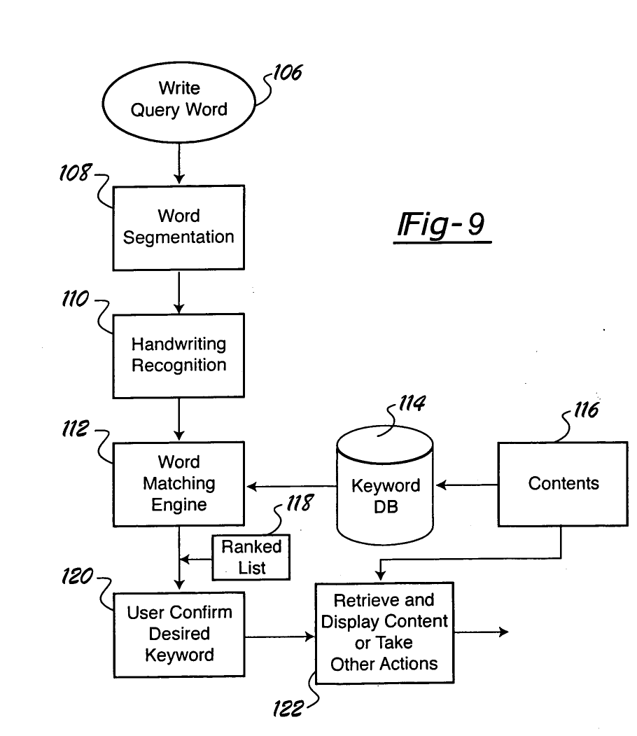

Handwriting may also be analyzed using a word-based search as illustrated in FIG. 9. After the user writes the word command at 106, the word undergoes segmentation at 108. The segmented word is then analyzed by handwriting recognition engine 110 and compared by word matching engine 112 to the words of keyword database 114, the words derived from program related contents 180. Word matching engine 112 then ranks the keywords of keyword database 114 according to the keywords that most closely approximate the query word 106 at 118. The user then confirms his/her desired keyword at 120 and the content associated with the user keyword is displayed at 122. Finally, any other actions associated with the entered keyword are also performed at 122.

The handwriting interpreter 74 can also handle numeric inputs when user searches channel directly by channel number. In this case, the recognized numeric numbers are used to look up channel station names in the keyword database.

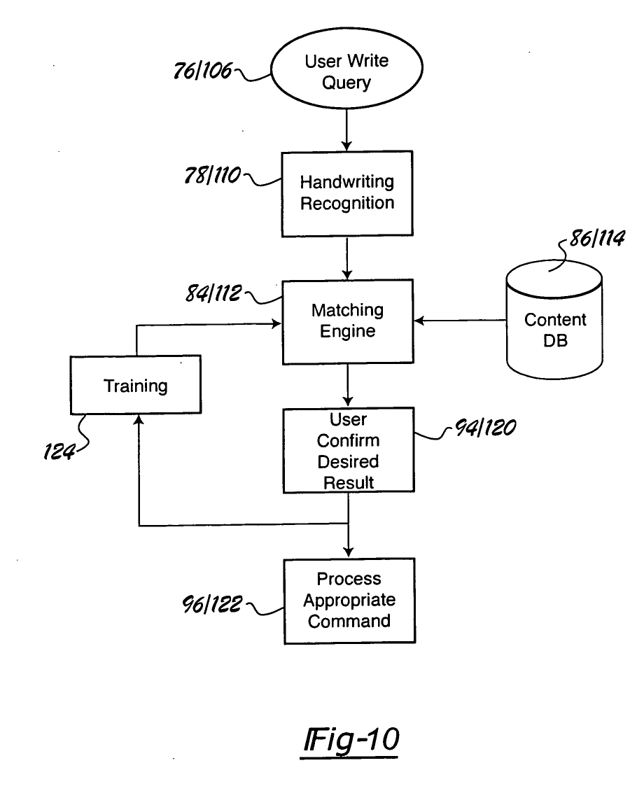

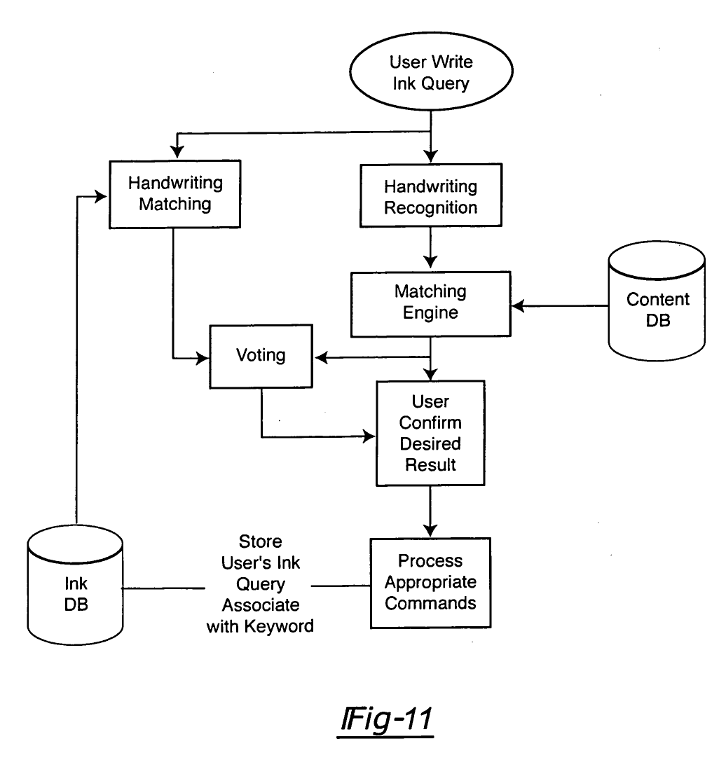

The handwriting interpreter 74 may also be self-training as seen in FIGS. 10 and 11. With reference to FIG. 10, training step 124 may be inserted into either the progressive search system (FIG. 7) or the word-based search system (FIG. 9). Specifically, at training step 124 the item selected by the user from the ranked list of results returned by the matching engine 84/112 is used to train the matching engine 84/112 to learn particular patterns of the handwriting recognition engine 78/110. These patterns may identify mistakes that the handwriting recognition engine 78/110 is likely to make, and consequently use such patterns to better guess when the handwriting recognition engine 78/110 generates invalid results. A simple example is that when handwriting recognition engine 78/110 often recognizes “c” as “e,” this pattern is learned and used next time by the matching engine 84/112. If confusion exists between “c” and “e”, the matching engine 84/112 can make a better guess based on the previous pattern it learned.

An additional hybrid self-training mechanism is illustrated in FIG. 11. The hybrid method employs the concept of self learning and records the user's previous handwriting query. When the user confirms a generated ranked list, his/her handwritten query is associated with the selected keyword text. For an incoming handwritten query, a handwritten recognition and a handwritten matching engine can be combined. The handwriting matching engine compares the handwritten query with previous handwritten queries, and finds the best match. Through a previous handwritten query that has been matched, its associated text keyword can be successfully located. The ink based handwriting matching is limited to user dependent matching and this limitation is resolved in the hybrid method, while a cursive handwritten query can also be handled. Further, the ink based handwriting matching requires user handwriting (ink database) to be entered in advance. When combining into the hybrid method, this ink database is accumulated through the self training process.

Commands entered via the GUI 66 may be directed to a variety of different locations as seen in FIG. 3. If the command is a direct operating command for television 14, or any other audio/video device, the command may be send to IR transmitter 126 for transmission directly to the television 14. If the command requests VBI data, the command may be sent to data manager 128 for subsequent transmission to the STB via wireless interface 130. However, it must be noted that the command may also be sent directly to the wireless interface 130 without first being sent to the data manager 128. Wireless interface 130 may be any suitable interface such as Bluetooth, IEEE 802.11b, USB, or IR.

In addition to operating the GUI applications 66 using keyboard/buttons 68, touch screen 70, or handwriting interpreter 74, commands may also be provided by any other suitable external data source 132. Further, the external data source 132 may also be used to operate applications 134 that are not GUI applications 66 but are rather internal applications over which the user has no control. Commands generated by the internal applications 134 may be transmitted directly to television 14 via IR transmitter 126 or to STB 16 via wireless interface 130. Additionally, the commands generated by applications 134 may be first transmitted to the data manager 128 and then subsequently transmitted to STB 16 through wireless interface 130.

STB 16 and hand-held device 12 may be operated according to a second embodiment as illustrated in FIG. 12. The second embodiment is similar to the first embodiment illustrated in FIG. 3. However, the second embodiment deals with digital broadcast signal particularly. The STB 273 (FIG. 12) includes a digital tuner 274, a demodulator 276 that outputs the transport stream (TS) from digital broadcasting signal, and a TS decoder 278 that splits the transport stream into data section and A/V section. Data section from transport stream may be cached in the data buffer 294. A/V section from TS decoder 278 can be decoded with the use of an AV decoder 280. The digital A/V data from AV decoder 282 can be directed to a digital TV set 284 through standard digital port such as digital visual interface (DVI) or high definition multimedia interface (HDMI). Alternatively, AV data from AV decoder 280 can also be encoded by NTSC/PAL encoder 282 and encoded analog signals sent to an analog TV.

The second embodiment also includes a data buffer 286, a data parser 288, a command processor 294, a data formatter 290, an IR transmitter 296, and a wireless interface 292. Once data is received in the data buffer, the process of manipulating data and transmit to the handheld 298 is the same as in FIG. 3. The handheld device 298 (FIG. 12) of the second embodiment is the same as the first embodiment.

It must be noted that the functionality of the handheld device 12 (FIG. 3) and set-top box 16 described above and as particularly described in FIGS. 3 and 12 may be modified so as to to make the operation less handheld-centric or set-top box centric. For example, some or all of the functionality of the device 12 (FIG. 3) may be deployed in some other box such as the STB 16, a digital video recorder, TV 14, or home gateway 18. Likewise, the functionality of the STB 16 may also be employed in some other box such as the STB 16, a digital video recorder 22, TV 14, or home gateway 18.

The use of the device 12 to carry out specific operations will now be described in detail. As seen in FIG. 13, device 12 is equipped with a menu 146 having numerous buttons 148 for operation of the device 12. Selection of the button 148 labeled “remote” from menu 146, results in the GUI 66 returning a remote control display 150. The remote control display 150 includes a plurality of menu “tabs” 152. The tabs 150 allow the user to select the particular device, including television 14, VCR 22, or a DVD and other home appliances (not shown) to be controlled remotely, with each tab 152 labeled to represent a different device. The devices listed on tabs 152 may be customized by the user according to the devices available to the user. As illustrated in FIG. 13, the tabs 152 are labeled TV, VCR, and DVD.

Upon selection of the particular tab 152 representing the device to be controlled remotely, the GUI produces a display with buttons for controlling the device selected. For example, if tab 152 labeled TV is selected then the screen 150 illustrated in FIG. 13 is produced. The screen 150 includes a numeric keypad 154 for television channel selection, volume control buttons 156, channel control buttons 158, and a power control button 160.

The screen 150 further includes a history of viewed channels display 162. The display 150 lists the channels viewed by the user in the order in which they were viewed with the most recent channel viewed presented at the top of the list. Alternately, the display 162 may list the channels according to the frequency of usage with the most frequently viewed channel at the top of the list. The GUI 66 is able to rank the channels according to frequency of usage. This display 162 allows the user to easily view any of the channels listed on the display 162 by simply tapping on the channel from the display 162.

Additionally, the screen 150 includes a natural handwriting input 164. The natural handwriting input 164 allows the user to write, using an appropriate device such as stylus 72, the channel number or the name of the channel to be viewed. As a result, users do not have to memorize the cable TV channel number of their favorite stations. For example, if the user wishes to view the Cable News Network, the user only needs to enter “CNN” within the natural handwriting input 164. Once the user enters the letters CNN, a listing of TV stations with names approximating the entry appears automatically in display 162 with the closest match appearing at the top of the list. The user may then select from the list the station that he/she desires to view. The natural handwriting input 164 is operated by the handwriting interpreter 74 discussed above.

The device 12 may also have a message display 166 for displaying simple messages such as current time, current viewing channel, name of program viewed, etc. In addition to display 166 and the other displays and buttons discussed above, the device 12 may have any number of additional displays or buttons to be used in conjunction with the operation of television 14 or any other device.

Selection of tabs 152 representing other devices, such as VCR 22 or DVD, to be operated by the handheld device 12 calls up screens that are similar to screen 150. However, unlike screen 150, the additional screens have buttons and controls specifically related to the operation of the particular device. For example, screens for the operation of VCR 22 or DVD will have play, record, or pause buttons. Because the additional screens are similar to screen 150, a detailed discussion of the additional screens is not necessary.

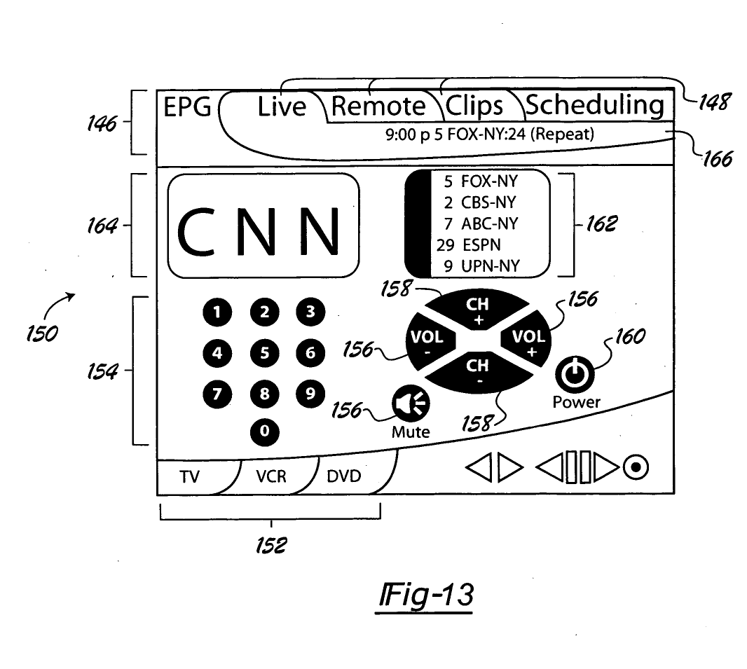

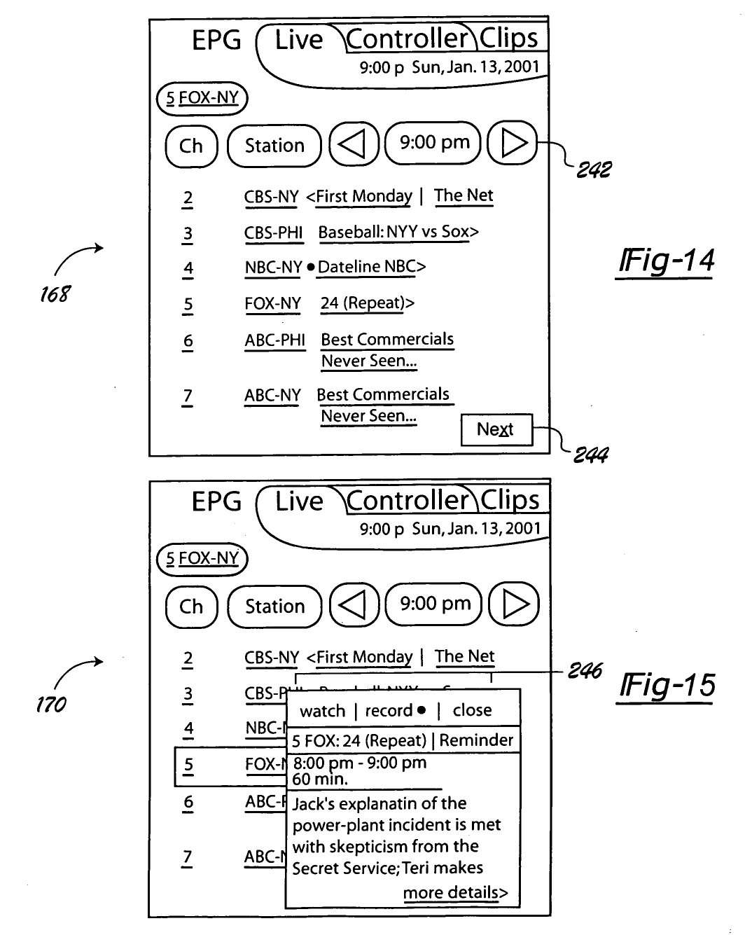

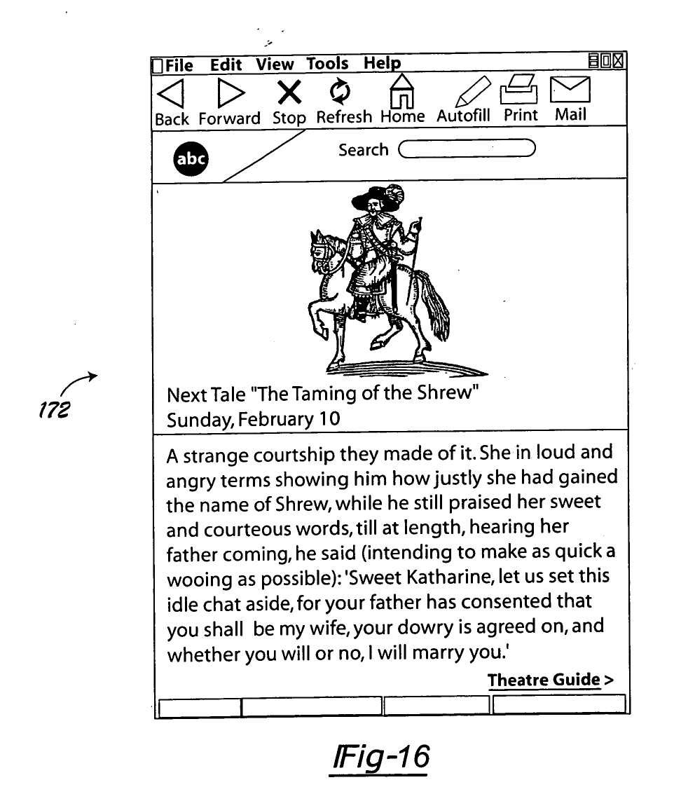

If the user selects the button 148 labeled EPG, the device 12 will return a screen displaying electronic program guide information (EPG). EPG information is generally provided in three levels of detail. The three levels of detail are program list view 168 (FIG. 14), program mini-review 170 (FIG. 15), and program full-review 172 (FIG. 16). The EPG information presented by the first two levels, program list view 168 and program mini-review 170, provides the user with only basic information such as program name, time, station, and a very brief program description. Additional information concerning the program, such as information about the cast, the particular episode, the program in general, and a picture gallery may be obtained using the program full-review 172.

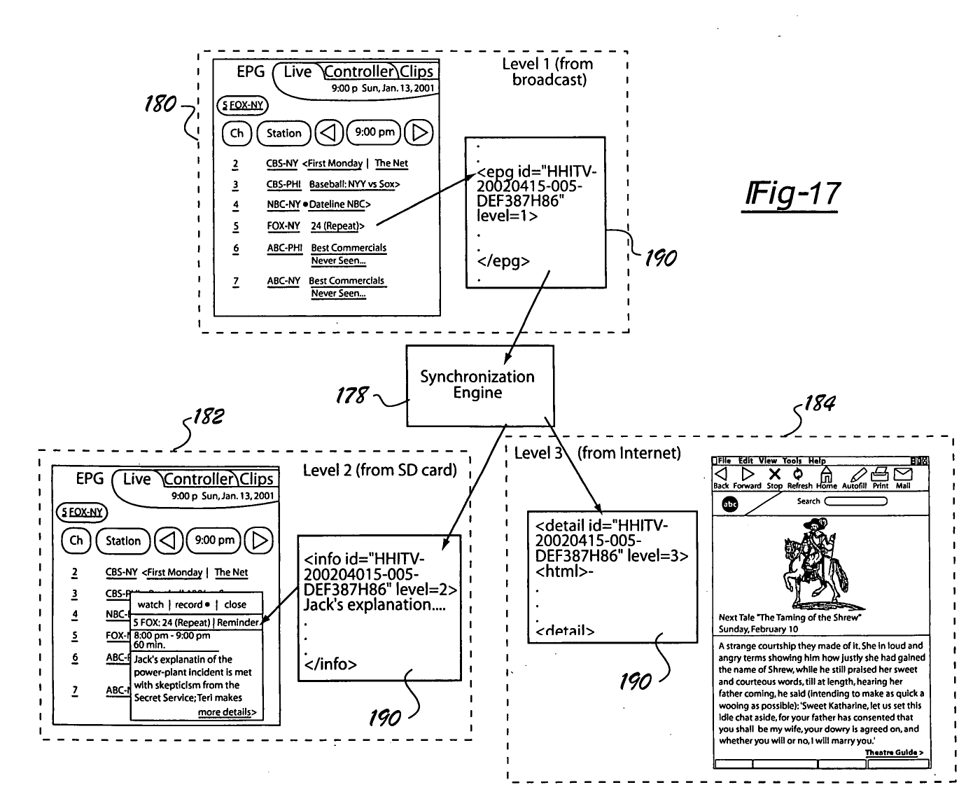

The EPG information provided by each level of detail may be obtained from a single source or a combination of different sources. Examples of EPG sources include auxiliary broadcasting channels from broadcast source 20 such as vertical blanking interval (VBI) for analog broadcasting, MPEG transport stream for digital broadcasting, optical encoding, Internet 174 via gateway 18, or from other external memory sources 176 such as an SD card, CF card, or compact disk. If more than one source is used to obtain the EPG information, a synchronization engine 178 must be used to bring all three levels of information into an easy to use interface FIG. 17. Synchronization engine 178 is incorporated within the data manager 128 of the handheld 12 for both first and second embodiment as illustrated in FIG. 3.

Operation of the synchronization engine 178 is illustrated in FIGS. 17 through 20. FIG. 17 illustrates use of synchronization engine 178 to synchronize EPG information obtained from the broadcast sources, an SD card, and from the Internet. As illustrated, the EPG information obtained from the broadcast is used to return the program list view at 180, the EPG information obtained from the SD card is used to return the program mini-review at 182, and the EPG information obtained from the Internet is used to return the program full review at 184.

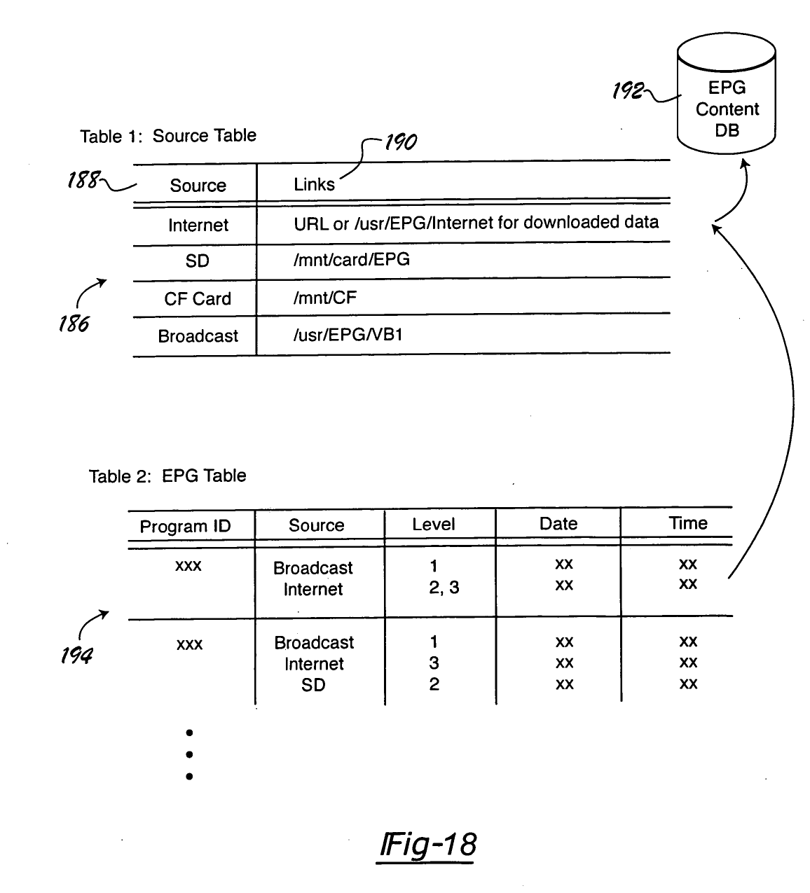

To properly synchronize the EPG data a source table 186 and an EPG table 194, as illustrated in FIG. 18, is created. As illustrated, source table 186 provides a listing of the different EPG sources 188 and links 190 used to access the sources. Examples of actual links 190 used to obtain EPG information is provided in FIG. 17. Downloaded EPG information is stored in the EPG content database 192 according to a format seen in EPG table 194. All EPG data is date and time stamped.

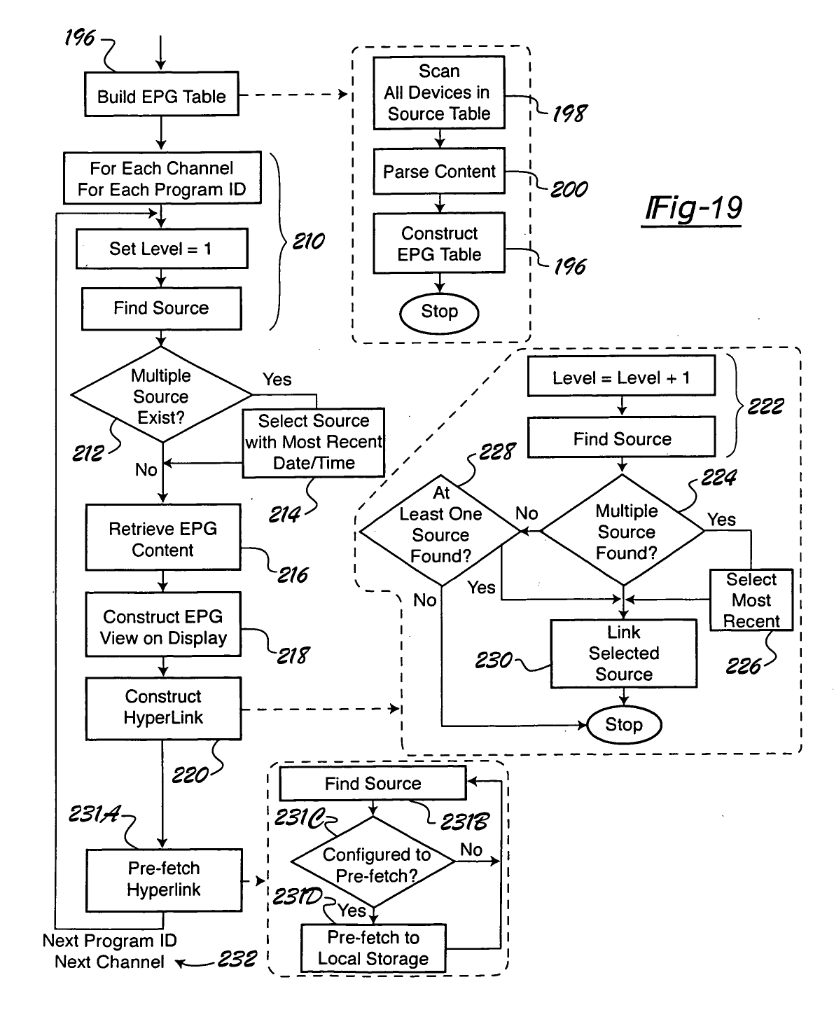

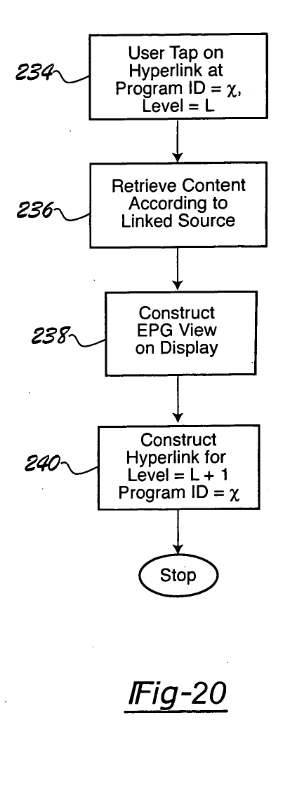

Use of EPG synchronization engine 178 to create EPG table 194 and source table 186 is illustrated in FIGS. 19 and 20. The step of building the EPG table 194 at 196 is accomplished by scanning all available EPG source devices in the source table 186 at 198. The content of the source devices 188 is parsed at 200 and used to construct the EPG table at 196. Once an EPG table has been created, the synchronization engine 178 locates the level 1 program list view 168, for each channel and each program at 210. The engine 178 scans the available sources to determine if multiple sources exist at 212. If multiple sources exist, the engine 178 selects the source with the most recent date and time stamp at 214 and retrieves the EPG content from the selected source at 216 using the source table 186. Using the retrieved EPG content, the engine 178 constructs the EPG view on the display of the device 12 at 218 and provides a hyperlink on the screen to the next level of EPG information.

The hyperlink to the next level of EPG information is constructed at 220. More specifically, the source of the next level of EPG information is located at 222 using the EPG table 194. If multiple sources are found at 224, the most recent source is selected at 226. If multiple sources are not found at 224 but at least source is found at 228 a link is provided to the selected source on device 12 at 230. If no source is found at 228, no link is provided. Once a hyperlink has been constructed to the next level at 220, the above process is repeated for subsequent programs and channels as illustrated at 232.

FIG. 20 illustrates the creation of a subsequent hyperlink to direct the user to level 3 EPG information. As illustrated, once the user selects at 234 the hyperlink created at 220, the content provided by the linked source is retrieved at 236 and provided on the display of the device 12 at 238, so as to provide the user with Level 2 EPG information. At 240 a hyperlink to level 3 EPG information is constructed in the same manner as illustrated at 220.

When multi-level of hyper-links is constructed recursively, some EPG contents can be configured to download to the handheld before user requests. This is implemented through pre-fetch hyperlink 231A as illustrated in FIG. 6. Some EPG contents can be pre-fetched and stored locally. A particular source for EPG can be predefined as pre-fetch or not-pre-fetch depending on the type of connections, for example, wireless LAN, fee based mobile network etc. If a source is not fee based, a pre-fetch can be enabled; therefore contents can be downloaded to local storage when the system is idle. If a source is fee based, pre-fetch will not be enabled. The enabling of pre-fetch can also depend on the depth (level) of the link and relativity to the original contents and so on.

The different EPG views along with use of the device 12 to operate and view the different EPG views will now be described in detail. When the user first selects the button 146 (FIG. 13) labeled EPG, the device 12 displays the program list view 168 as the default view. As seen in FIG. 14, program list view 168 only provides raw scheduling information such as a listing of the different programs available from the different channels during the current time slot. If the viewer wishes to view additional channels or the programming available at different time slots, the user may do so by tapping next page button 244 or the shift button 242.

When the user selects a particular program, the device displays the program mini-review 170. As seen in FIG. 15, the program mini-review 170 provides a brief summary of the program selected. The program mini-review 170 also presents the user with additional selection buttons 246 such as “watch,” “record,” “close,” “reminder,” or “more details.”

If the user selects “close” then the device 12 will switch from program mini-review 170 back to program list view 168. If the user selects “watch,” the device 12 will send an instruction to the STB 16 or to the television 14 in the manner described above so as to display the selected television program on the television screen 32. If the user selects “record,” the device 12 will send an instruction to the appropriate device, such as a VCR, and the program will be recorded by the device. This operation is controlled by AN control module 248. If the user selects “reminder”, the device 12 will send an alert when program is about to start. If the user selects “more details,” the program full review 172 will be displayed.

As seen in FIG. 16, the program full review 172 may display information in a web page format, such as HTML within a browser. The program full review 172 provides the user with p more complete description of the upcoming episode and of the particular television program than the program mini-review 170. Additionally, the program full review 172 allows the user to view additional graphics and video clips of past episodes, the upcoming episode, and the cast of the show.

In addition to using the EPG information for reviewing programming details, the EPG information may also be used for personal scheduling. For example, selection of the scheduling button from menu 146 returns a scheduling screen, such as but not limited to that displayed on device 12 in FIG. 1. As illustrated in FIG. 1, the scheduling screen 250 is divided into two halves. The first half of the screen 250 displays program list view 168. The second half of the screen 252 contains a personal scheduler displaying any day of the month selected by the user with each day being subdivided into the hours of the day.

The user may use the device 12 to incorporate the EPG information within his/her own personal schedule. For example, once the user locates a program that he/she wishes to view later, he/she may select the program listing, using stylus 72 for example, and then drag a copy of the program listing from the program list view 250 to the personal scheduler 252, inserting the program within the appropriate time slot during which the program will air. Having the program entered into the user's own personal schedule will prevent the user from scheduling an appointment conflicting with the selected program and will remind the user to view the program. This operation is illustrated in FIG. 1. As illustrated, program content 254 is incorporated into a calendar data structure 256 using scheduling algorithms 258 or any other suitable method.

The device 12 can be used to not only provide the user with a reminder to view the program selected, but it may also be used to record the program. Upon selection of the desired program the user may request that the program be recorded by a suitable recording device such as VCR 22. If this option is selected, at the start of the program a signal providing recording instructions will be transmitted from the device 12 using a suitable interface such as IEEE 802.11b or Bluetooth. The signal may be directly received by the VCR 22 or it may be sent through the STB 16 and delivered to the VCR 22 via the IR transmitter 50. However, if both the handheld device 12 and the recording device 22 are connected to the Internet 174, the handheld device 12 may transmit the command to record the program from any remote location.

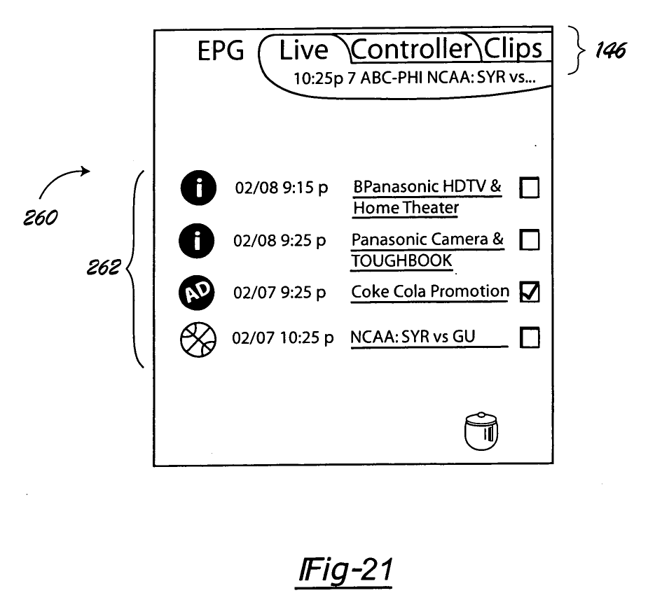

Data stored in the data manager 128 may be viewed off-line using the “Clips” button found in menu 146. Selection of the “Clips” button returns a clip inventory screen 260 as seen in FIG. 21. Listed on screen 260 are four clips 262 that have been previously stored by the user of the handheld device 12. The clips 262 stored by the user may represent almost any type of data including informational texts, advertisements, or sports highlights. The amount of data stored is only limited by the size of the memory of handheld device 12.

The handheld device 12 associates tags or metadata with the clips 262. As a result, the user may integrate clips 262 with other information downloaded from another source, such as the Internet 174. For example, a clip of a commercial may be associated with a website for the product advertised. Selection of the clip would direct the user to the product website where the user would be presented with a digital coupon. The coupon could later be used to purchase the product advertised and may be configured to interact electronically with a point of purchase system to apply the appropriate discount.

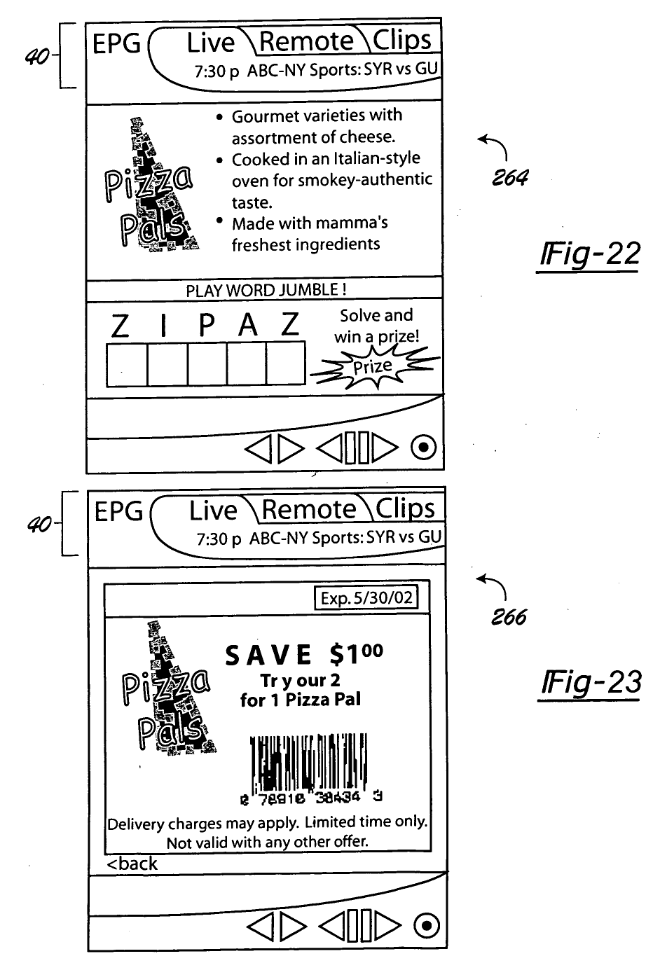

When the user selects the button labeled “Live” from menu bar 146, the device returns a screen 264 as seen in FIG. 22. The live function allows the handheld device 12 to continuously receive program related data while the user is watching the selected program. The data is provided by content providers during the VBI to supplement their on-air programming. Examples of live data include supplementary text, triggers, advertisements, interactive contents etc. Screen 264 of FIG. 22 illustrates an example of an advertisement that may be received by device 12. The advertisement provides information about a particular product and presents a game for the user to play. If the game is won the user is rewarded with a prize such as a coupon 266 providing a discount on the product advertised (FIG. 23). The live data can be saved locally for viewing at a later time.

The device 12 is capable of analyzing the usage patterns of any or all of the above functions so as to adapt itself to operate in the user's preferred manner in the future. For example, if the user most often views The History Channel and most often sets the television volume intensity to level five out of ten, when the television is powered on the device will automatically tune the television to The History Channel and set the volume intensity at level 5. Further, if the user repeatedly records a particular soap opera each day at a certain time but one day forgets to record the program, the device 12 will recognize this change in usage and alert the user that he/she has forgotten to record the program.

Suitable algorithms 268 may be used to carry out the usage pattern analysis 270 as illustrated in FIG. 1. The operation of the above algorithms and the settings chosen by the algorithms may be displayed either on the device 12 or on the television screen 32. Consequently, the user can readily see how the device 12 will perform using the algorithms and can override the use of the algorithms if they are not producing the desired results.

The handheld device 12 may also be configured to convert the EPG and close-captioning information from text to speech. Such a feature would allow the user to interact with the device 12 while carrying out another task such as operating an automobile. Further the handheld device 12 may be equipped with the added functionality of being able to translate the EPG or close-captioning data into another language. Such a feature would be particularly useful for a person who lacks proficiency in the language in which the EPG or close-captioning information is originally transmitted.

It must be noted that while the above invention places emphasis on the use of VBI data for analog boradcasting, the invention may also be used with digital television. Specifically, in a digital video implementation, program content and digital data content may be combined directly as MPEG transport stream.

The description of the invention is merely exemplary in nature and, thus, variations that do not depart from the gist of the invention are intended to be within the scope of the invention. Such variations are not to be regarded as a departure from the spirit and scope of the invention.

1. A scheduling system adapted to avoid scheduling conflicts for use with a hand-held remote control device integrated with multiple information sources, comprising:
an electronic schedule of personal events adapted to commonly schedule electronic media events with scheduled personal events;
a user interface adapted to simultaneously communicate scheduled personal events and available electronic media events to a user, wherein the scheduled personal events and the available electronic media events have predefined times and durations; and
a scheduling module adapted to identify and resolve a conflict between an electronic media event and a scheduled personal event.

2-6. (canceled)

7. A clip organization system adapted to organize media-related information for use with a hand-held device, comprising:
an input receptive of media-related information extracted from a television broadcast stream;
a data store storing the media-related information; and
an electronic index organizing the media-related information to facilitate retrieval of the media related information by the user.

8-11. (canceled)

12. A remote control system adapted to control electronic media devices for use with a had-held remote control device, comprising:
a data store storing information relating to electronic media event consumption via the electronic media devices;
a usage pattern analysis module adapted to perform an analysis of previous user consumption of electronic media events via electronic media devices, and adapted to anticipating user preferences relating to electronic media event consumption via the electronic media devices based on the analysis; and
a user interface adapted to acting on anticipation of user preferences to accomplish improved enjoyment of media content by the user via the electronic media devices.

13-14. (canceled)

15. An information delivery system adapted to delivering program-related information content to a user via a hand-held device, comprising:
a data decoder adapted to extract program-related information content from a broadcast signal;
a parser adapted to identify a category associated with the program-related information content; and
a user interface adapted to employ a template assigned to the category to display the program-related information content to the user via an active display of the hand-held device.

16-19. (canceled)

20. A user interface system for use with a hand-held apparatus, comprising:
a handwriting recognition module adapted to recognize a handwritten user query;
a handwriting matching engine adapted to match the query to a plurality of options including at least one of available electronic media events and broadcast channels rendering the electronic media events available to the user; and
an active display communicating the plurality of options to the user as a list of ranked options.

21-23. (canceled)

24. An electronic programming guide maintenance system for use with a hand-held device, comprising:
an input receptive of identifications of available electronic media content, wherein the identifications are extracted from a broadcast signal operable to deliver the available electronic media content;
a second input in communication with a communications system having electronic programming guide information providing details relating to the available media content; and
a synchronization engine adapted to construct and maintain links between the identifications of available electronic media content and related electronic programming guide information.

25. (canceled)

26. A method of avoiding scheduling conflicts for use with a hand-held remote control device integrated with multiple information sources, comprising:
maintaining an electronic schedule of personal events, wherein the electronic schedule is adapted to commonly schedule electronic media events with scheduled personal events;
simultaneously communicating scheduled personal events and available electronic media events to a user, wherein the scheduled personal events and the available electronic media events have predefined times and durations; and
identifying and resolving a conflict between an electronic media event and a scheduled personal event.

27-31. (canceled)

32. A method of organizing media-related information for use with a hand-held device, comprising:
receiving media-related information extracted from a television broadcast stream;
storing the media-related information in computer memory; and
organizing the media-related information to facilitate retrieval of the media related information by the user.

33-36. (canceled)

37. A method of controlling electronic media devices for use with a had-held remote control device, comprising:
performing an analysis of previous user consumption of electronic media events via electronic media devices, wherein the electronic media devices were operated by the user via the hand-held remote control device;
anticipating user preferences relating to electronic media event consumption via the electronic media devices based on the analysis; and
acting on anticipation of user preferences to accomplish improved enjoyment of media content by the user via the electronic media devices.

38-39. (canceled)

40. A method of delivering program-related information content to a user via a hand-held device, comprising:
extracting program-related information content from a broadcast signal;
identifying a category associated with the program-related information content; and
using a pre-defined template assigned to the category to display the program-related information content to the user via an active display of the hand-held device.

41-44. (canceled)

45. A method of providing a user interface for use with a hand-held apparatus, comprising:
recognizing a handwritten user query;
matching the query to a plurality of options including at least one of available electronic media events and broadcast channels rendering the electronic media events available to the user; and
communicating the plurality of options to the user as a list of ranked options.

46-48. (canceled)

49. A method of maintaining an electronic programming guide for use with a hand-held device, comprising:
receiving identifications of available electronic media content, wherein the identifications are extracted from a broadcast signal operable to deliver the available electronic media content;
communicating with a communications system having electronic programming guide information providing details relating to the available media content; and
constructing and maintaining links between the identifications of available electronic media content and related electronic programming guide information.

50-53. (canceled)

54. The system of claim 1, further comprising a synchronization engine downloading supplementary information over a communications system based on identifying information extracted from media content before the supplementary information is requested by a user, storing the supplementary information in a content database, and subsequently, synchronously delivering the supplementary information with media content to which the supplementary information is related, regardless of whether a connection to the communications system is available at time of delivery.

55. The system of claim 54, wherein said synchronization engine receives the media content from a source of media content other than the communications system.

56. The system of claim 55, wherein said synchronization engine further stores the media content to which the supplementary information is related for subsequent, synchronous delivery with the supplementary information, regardless of whether a connection to the source of media content is available at time of delivery.

57. The system of claim 56, wherein the media content to which the supplementary information is related corresponds to one level of EPG contents, and the supplementary information corresponds to another level of EPG contents.

58. The method of claim 26, further comprising:
downloading supplementary information over a communications system based on identifying information extracted from media content before the supplementary information is requested by a user, wherein the source of supplementary information is different from a source of media content;
storing the supplementary information in a content database; and
subsequent to downloading and storing of the supplementary information, synchronously delivering the supplementary information with media content to which the supplementary information is related, regardless of whether a connection to the communications system is available at time of delivery.

59. The method of claim 58, further comprising receiving the media content from a source of media content other than the communications system.

60. The method of claim 59, further comprising storing the media content to which the supplementary information is related for subsequent, synchronous delivery with the supplementary information regardless of whether a connection to the source of media content is available at time of delivery.

61. The method of claim 60, wherein the media content to which the supplementary information is related corresponds to one level of EPG contents, the supplementary information corresponds to another level of EPG contents.

62. The system of claim 1 further comprising a handwriting matching engine that analyzes user handwriting inputs character by character using a progressive search that removes search results from and adds search results to a list for final selection as new characters are entered and combined with previously entered characters in a search string, wherein character misrecognition and non-recognition are accommodated by adding misrecognized and non-recognized user handwriting inputs to the search string and looking for approximate matches.

63. The method of claim 26 further comprising:
analyzing user handwriting inputs character by character using a progressive search that removes search results from and adds search results to a list for final selection as new characters are entered and combined with previously entered characters in a search string, wherein character misrecognition and non-recognition are accommodated by adding misrecognized and non-recognized user handwriting inputs to the search string and looking for approximate matches.

64. The system of claim 7, further comprising a synchronization engine downloading supplementary information over a communications system based on identifying information extracted from media content before the supplementary information is requested by a user, storing the supplementary information in a content database, and subsequently, synchronously delivering the supplementary information with media content to which the supplementary information is related, regardless of whether a connection to the communications system is available at time of delivery.

65. The system of claim 64, wherein said synchronization engine receives the media content from a source of media content other than the communications system.

66. The system of claim 65, wherein said synchronization engine further stores the media content to which the supplementary information is related for subsequent, synchronous delivery with the supplementary information, regardless of whether a connection to the source of media content is available at time of delivery.

67. The system of claim 66, wherein the media content to which the supplementary information is related corresponds to one level of EPG contents, and the supplementary information corresponds to another level of EPG contents.

68. The method of claim 32, further comprising:
downloading supplementary information over a communications system based on identifying information extracted from media content before the supplementary information is requested by a user, wherein the source of supplementary information is different from a source of media content;
storing the supplementary information in a content database; and
subsequent to downloading and storing of the supplementary information, synchronously delivering the supplementary information with media content to which the supplementary information is related, regardless of whether a connection to the communications system is available at time of delivery.

69. The method of claim 68, further comprising receiving the media content from a source of media content other than the communications system.

70. The method of claim 69, further comprising storing the media content to which the supplementary information is related for subsequent, synchronous delivery with the supplementary information regardless of whether a connection to the source of media content is available at time of delivery.

71. The method of claim 70, wherein the media content to which the supplementary information is related corresponds to one level of EPG contents, the supplementary information corresponds to another level of EPG contents.

72. The system of claim 7, further comprising a handwriting matching engine that analyzes user handwriting inputs character by character using a progressive search that removes search results from and adds search results to a list for final selection as new characters are entered and combined with previously entered characters in a search string, wherein character misrecognition and non-recognition are accommodated by adding misrecognized and non-recognized user handwriting inputs to the search string and looking for approximate matches.

73. The method of claim 32, further comprising:
analyzing user handwriting inputs character by character using a progressive search that removes search results from and adds search results to a list for final selection as new characters are entered and combined with previously entered characters in a search string, wherein character misrecognition and non-recognition are accommodated by adding misrecognized and non-recognized user handwriting inputs to the search string and looking for approximate matches.

74. The system of claim 12, further comprising a synchronization engine downloading supplementary information over a communications system based on identifying information extracted from media content before the supplementary information is requested by a user, storing the supplementary information in a content database, and subsequently, synchronously delivering the supplementary information with media content to which the supplementary information is related, regardless of whether a connection to the communications system is available at time of delivery.

75. The system of claim 74, wherein said synchronization engine receives the media content from a source of media content other than the communications system.

76. The system of claim 75, wherein said synchronization engine further stores the media content to which the supplementary information is related for subsequent, synchronous delivery with the supplementary information, regardless of whether a connection to the source of media content is available at time of delivery.

77. The system of claim 76, wherein the media content to which the supplementary information is related corresponds to one level of EPG contents, and the supplementary information corresponds to another level of EPG contents.

78. The method of claim 37, further comprising:
downloading supplementary information over a communications system based on identifying information extracted from media content before the supplementary information is requested by a user, wherein the source of supplementary information is different from a source of media content;
storing the supplementary information in a content database; and
subsequent to downloading and storing of the supplementary information, synchronously delivering the supplementary information with media content to which the supplementary information is related, regardless of whether a connection to the communications system is available at time of delivery.

79. The method of claim 78, further comprising receiving the media content from a source of media content other than the communications system.

80. The method of claim 79, further comprising storing the media content to which the supplementary information is related for subsequent, synchronous delivery with the supplementary information regardless of whether a connection to the source of media content is available at time of delivery.

81. The method of claim 80, wherein the media content to which the supplementary information is related corresponds to one level of EPG contents, the supplementary information corresponds to another level of EPG contents.

82. The system of claim 12, further comprising a handwriting matching engine that analyzes user handwriting inputs character by character using a progressive search that removes search results from and adds search results to a list for final selection as new characters are entered and combined with previously entered characters in a search string, wherein character misrecognition and non-recognition are accommodated by adding misrecognized and non-recognized user handwriting inputs to the search string and looking for approximate matches.

83. The method of claim 37, further comprising:
analyzing user handwriting inputs character by character using a progressive search that removes search results from and adds search results to a list for final selection as new characters are entered and combined with previously entered characters in a search string, wherein character misrecognition and non-recognition are accommodated by adding misrecognized and non-recognized user handwriting inputs to the search string and looking for approximate matches.

84. The system of claim 15, further comprising a synchronization engine downloading supplementary information over a communications system based on identifying information extracted from media content before the supplementary information is requested by a user, storing the supplementary information in a content database, and subsequently, synchronously delivering the supplementary information with media content to which the supplementary information is related, regardless of whether a connection to the communications system is available at time of delivery.

85. The system of claim 84, wherein said synchronization engine receives the media content from a source of media content other than the communications system.

86. The system of claim 85, wherein said synchronization engine further stores the media content to which the supplementary information is related for subsequent, synchronous delivery with the supplementary information, regardless of whether a connection to the source of media content is available at time of delivery.

87. The system of claim 86, wherein the media content to which the supplementary information is related corresponds to one level of EPG contents, and the supplementary information corresponds to another level of EPG contents.

88. The method of claim 40, further comprising:
downloading supplementary information over a communications system based on identifying information extracted from media content before the supplementary information is requested by a user, wherein the source of supplementary information is different from a source of media content;
storing the supplementary information in a content database; and
subsequent to downloading and storing of the supplementary information, synchronously delivering the supplementary information with media content to which the supplementary information is related, regardless of whether a connection to the communications system is available at time of delivery.

89. The method of claim 88, further comprising receiving the media content from a source of media content other than the communications system.

90. The method of claim 89, further comprising storing the media content to which the supplementary information is related for subsequent, synchronous delivery with the supplementary information regardless of whether a connection to the source of media content is available at time of delivery.

91. The method of claim 90, wherein the media content to which the supplementary information is related corresponds to one level of EPG contents, the supplementary information corresponds to another level of EPG contents.

92. The system of claim 15, further comprising a handwriting matching engine that analyzes user handwriting inputs character by character using a progressive search that removes search results from and adds search results to a list for final selection as new characters are entered and combined with previously entered characters in a search string, wherein character misrecognition and non-recognition are accommodated by adding misrecognized and non-recognized user handwriting inputs to the search string and looking for approximate matches.

93. The method of claim 40, further comprising:
analyzing user handwriting inputs character by character using a progressive search that removes search results from and adds search results to a list for final selection as new characters are entered and combined with previously entered characters in a search string, wherein character misrecognition and non-recognition are accommodated by adding misrecognized and non-recognized user handwriting inputs to the search string and looking for approximate matches.

94. The system of claim 20, further comprising a synchronization engine downloading supplementary information over a communications system based on identifying information extracted from media content before the supplementary information is requested by a user, storing the supplementary information in a content database, and subsequently, synchronously delivering the supplementary information with media content to which the supplementary information is related, regardless of whether a connection to the communications system is available at time of delivery.

95. The system of claim 94, wherein said synchronization engine receives the media content from a source of media content other than the communications system.

96. The system of claim 95, wherein said synchronization engine further stores the media content to which the supplementary information is related for subsequent, synchronous delivery with the supplementary information, regardless of whether a connection to the source of media content is available at time of delivery.

97. The system of claim 96, wherein the media content to which the supplementary information is related corresponds to one level of EPG contents, and the supplementary information corresponds to another level of EPG contents.

98. The method of claim 45, further comprising:
downloading supplementary information over a communications system based on identifying information extracted from media content before the supplementary information is requested by a user, wherein the source of supplementary information is different from a source of media content;
storing the supplementary information in a content database; and
subsequent to downloading and storing of the supplementary information, synchronously delivering the supplementary information with media content to which the supplementary information is related, regardless of whether a connection to the communications system is available at time of delivery.

99. The method of claim 98, further comprising receiving the media content from a source of media content other than the communications system.

100. The method of claim 99, further comprising storing the media content to which the supplementary information is related for subsequent, synchronous delivery with the supplementary information regardless of whether a connection to the source of media content is available at time of delivery.

101. The method of claim 100, wherein the media content to which the supplementary information is related corresponds to one level of EPG contents, the supplementary information corresponds to another level of EPG contents.

102. The system of claim 20, further comprising a handwriting matching engine that analyzes user handwriting inputs character by character using a progressive search that removes search results from and adds search results to a list for final selection as new characters are entered and combined with previously entered characters in a search string, wherein character misrecognition and non-recognition are accommodated by adding misrecognized and non-recognized user handwriting inputs to the search string and looking for approximate matches.

103. The method of claim 45, further comprising:
analyzing user handwriting inputs character by character using a progressive search that removes search results from and adds search results to a list for final selection as new characters are entered and combined with previously entered characters in a search string, wherein character misrecognition and non-recognition are accommodated by adding misrecognized and non-recognized user handwriting inputs to the search string and looking for approximate matches.

104. The system of claim 24, further comprising a synchronization engine downloading supplementary information over a communications system based on identifying information extracted from media content before the supplementary information is requested by, a user, storing the supplementary information in a content database, and subsequently, synchronously delivering the supplementary information with media content to which the supplementary information is related, regardless of whether a connection to the communications system is available at time of delivery.

105. The system of claim 104, wherein said synchronization engine receives the media content from a source of media content other than the communications system.

106. The system of claim 105, wherein said synchronization engine further stores the media content to which the supplementary information is related for subsequent, synchronous delivery with the supplementary information, regardless of whether a connection to the source of media content is available at time of delivery.

107. The system of claim 106, wherein the media content to which the supplementary information is related corresponds to one level of EPG contents, and the supplementary information corresponds to another level of EPG contents.

108. The method of claim 49, further comprising:
downloading supplementary information over a communications system based on identifying information extracted from media content before the supplementary information is requested by a user, wherein the source of supplementary information is different from a source of media content;
storing the supplementary information in a content database; and
subsequent to downloading and storing of the supplementary information, synchronously delivering the supplementary information with media content to which the supplementary information is related, regardless of whether a connection to the communications system is available at time of delivery.

109. The method of claim 108, further comprising receiving the media content from a source of media content other than the communications system.

110. The method of claim 109, further comprising storing the media content to which the supplementary information is related for subsequent, synchronous delivery with the supplementary information regardless of whether a connection to the source of media content is available at time of delivery.

111. The method of claim 110, wherein the media content to which the supplementary information is related corresponds to one level of EPG contents, the supplementary information corresponds to another level of EPG contents.

112. The system of claim 24, further comprising a handwriting matching engine that analyzes user handwriting inputs character by character using a progressive search that removes search results from and adds search results to a list for final selection as new characters are entered and combined with previously entered characters in a search string, wherein character misrecognition and non-recognition are accommodated by adding misrecognized and non-recognized user handwriting inputs to the search string and looking for approximate matches.

113. The method of claim 49, further comprising:
analyzing user handwriting inputs character by character using a progressive search that removes search results from and adds search results to a list for final selection as new characters are entered and combined with previously entered characters in a search string, wherein character misrecognition and non-recognition are accommodated by adding misrecognized and non-recognized user handwriting inputs to the search string and looking for approximate matches.
